(19) United States
(12) Patent Application Publication
(10) Pub. No.: US 2005/0024024 A1
(43) Pub. Date: Feb. 3, 2005

(54) Voltage regulator for electronic device

(76) Inventors: Vincent Lomba, Houilles (FR); Christophe Rouverand, Saint Germain En Laye (FR)

Correspondence Address: SUGHRUE MION, PLLC, 2100 PENNSYLVANIA AVENUE, N.W., SUITE 800, WASHINGTON, DC, 20037, US

(21) Appl. No.: 10/469,186

(22) PCT Filed: Dec. 24, 2002
(86) PCT No.: PCT/FR02/04547

(30) Foreign Application Priority Data
Jan. 3, 2002 (FR) 02/00031

(51) Int. Cl. G05F 1/10

(52) U.S. Cl. 323/222

(57) ABSTRACT

A voltage regulator for an electronic device, the regulator supplying a regulated output voltage from an input voltage, the output voltage being applied to an electronic subsystem of the electronic device adapted to be supplied with power, said regulator comprising a controller receiving the input voltage, a capacitor situated at the output of the regulator and adapted to be charged periodically by the input voltage and periodically to supply its charge to the electronic subsystem of the electronic device when said electronic subsystem requires to be supplied with power, the capacitor being connected in parallel with a feedback network for sampling a portion of the output voltage and supplying a measured value of the output voltage to the controller, the feedback network comprising at least two transistors, a voltage comparator, and a switch situated between the output of the comparator and the input of the controller, which voltage regulator is characterized in that a switch is inserted into the feedback network between the input of the feedback network and the first transistor, the switch being open when the electronic subsystem requires no power.

The present invention relates to a voltage regulator for an electronic device, for example a radio terminal; the voltage regulator is intended to provide a regulated output voltage to an electronic subsystem of the terminal from an input voltage connected to an energy store.

One non-exclusive field of application of the invention is that of mobile radio terminals operating in a cellular radio system. The invention applies in particular, although not exclusively, to a system conforming to the Global System for Mobile communications (GSM) standard.

A voltage regulator provides the exact voltage required by an electronic subsystem of a radio terminal so that it operates in an optimum manner.

The voltage supplied must be accurate and very stable, as otherwise the electronic subsystem could be irreversibly damaged, which would necessitate costly replacement of the subsystem.

A regulator of the above type can be used between an energy store such as a storage battery and a radio preamplifier. A radio preamplifier controls transmission and reception of radio signals by the radio terminal.

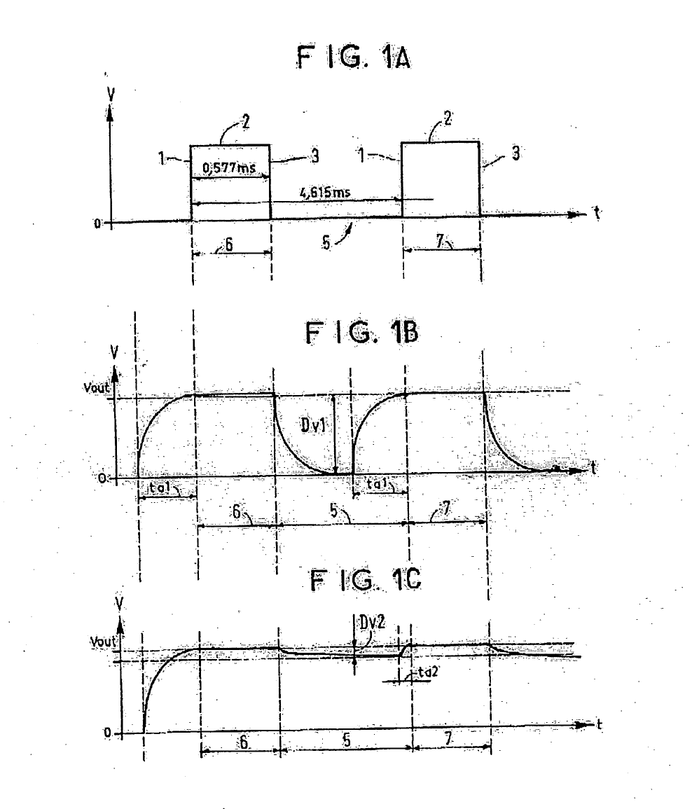

When the terminal is operating, the radio frequency (RF) signal is transmitted or received only during a particular time interval recurring with a period fixed by the reference clock of the network, and thus takes the form of a varying pulse signal, as shown in FIG. 1A, which shows a GSM signal.

FIG. 1A shows the fact that the power amplifiers are subjected to a sudden rise 1 in voltage and then at the end of the pulse 2 to a sudden fall 3 in the voltage, followed by a zero voltage time interval 5.

The period T of the GSM signal shown is 4.615 ms. It can be seen that the duration of the pulse 2 of the signal is 0.577 ms.

To provide the necessary voltage to the radio preamplifier at the correct time, the voltage regulator must be deactivated at the end of the first high voltage time interval (6) and reactivated before the second high voltage time interval (7). This is known in the art.

FIG. 1B shows that the voltage regulator is reactivated ta1 ms before the second high voltage time interval (7) in order for the output voltage of the regulator to reach the necessary value (Vout) for the radio preamplifier to function in an optimum manner.

Accordingly, the voltage regulator must go from a zero output voltage to the necessary output voltage Vout, which represents a voltage difference Dv1.

This causes a considerable loss of energy since for each voltage rise the voltage regulator must recharge to the voltage Dv1 after it has been reactivated, which occurs around 200 times per second, as there is a voltage rise every 4.615 ms.

Another loss of energy stems from the fact that there is a leakage current in the voltage regulator during time intervals in which the electronic subsystem does not require power.

An object of the invention is to provide a solution to the above problems, to regulate the voltage delivered to the radio preamplifier, and to limit the energy losses.

To this end, the invention proposes a voltage regulator for an electronic device, the regulator supplying a regulated output voltage from an input voltage, the output voltage being applied to an electronic subsystem of the electronic device adapted to be supplied with power, said regulator comprising a controller receiving the input voltage, a capacitor situated at the output of the regulator and adapted to be charged periodically by the input voltage and periodically to supply its charge to the electronic subsystem of the electronic device when said electronic subsystem requires to be supplied with power, the capacitor being connected in parallel with a feedback network for sampling a portion of the output voltage and supplying a measured value of the output voltage to the controller, the feedback network comprising at least two transistors, a voltage comparator, and a switch situated between the output of the comparator and the input of the controller, which voltage regulator is characterized in that a switch is inserted into the feedback network between the input of the feedback network and the first transistor, the switch being open when the electronic subsystem requires no power.

Thus the invention reduces the regulator reactivation time before the voltage rise and the energy needed to recharge the regulator.

In one particular embodiment, the voltage comparator (COMP) compares the sampled portion of the output voltage to a reference voltage (Vref) characteristic of the electronic subsystem adapted to be supplied with power, and is a control transistor.

Other features and advantages of the invention will become apparent on reading the following description of one particular embodiment of the invention, which is given by way of illustrative and nonlimiting example, and examining the drawings listed below.

FIG. 1A, already described, represents the varying waveform of a GSM signal.

FIG. 1B, already described, represents the output voltage of a prior art voltage regulator.

FIG. 1C represents the output voltage of a voltage regulator according to the invention.

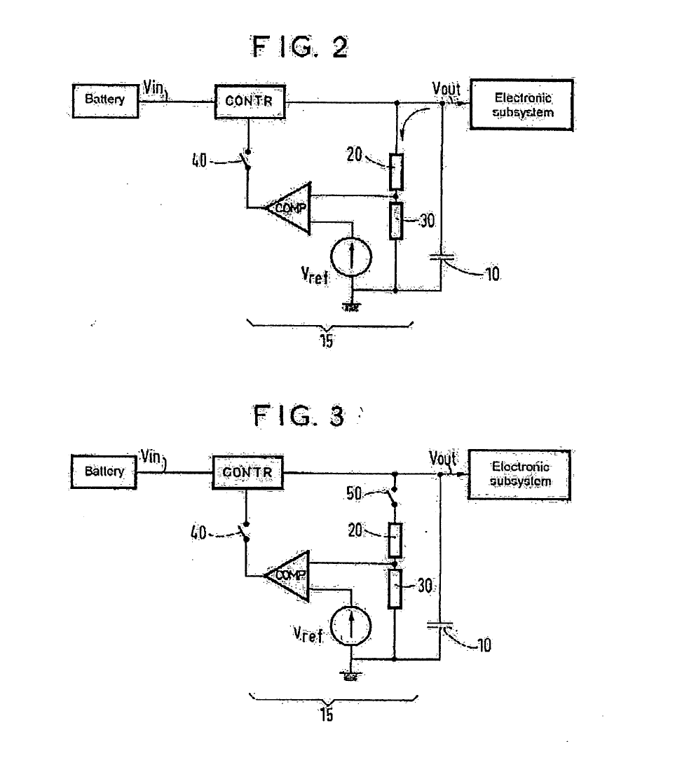

FIG. 2 represents the electrical circuit diagram of a prior art voltage regulator.

FIG. 3 represents the electrical circuit diagram of a voltage regulator according to the invention.

The remainder of the description describes the application of the invention to radio terminals or mobile telephones. It applies more generally to any type of radio transceiver, for example a radio paging device.

As described here, the voltage regulator circuit according to the invention serves as an intermediate stage between an energy store and the radio portion of the terminal, for example the radio preamplifier.

The circuit can equally well be applied to supplying power to other electronic subsystems of the terminal, such as the core of a microprocessor, for example.

The regulator of the invention provides optimum stability of the voltage delivered to the electronic subsystem of the terminal.

FIG. 2 represents the electrical circuit diagram of a prior art voltage regulator.

The voltage regulator supplies a regulated output voltage (Vout) to an electronic subsystem of the communication terminal to be supplied with power.

The regulator is itself connected to an energy store which supplies it with power at an input voltage (Vin).

The regulator includes a controller (CONTR), which is generally a regulation control transistor receiving the input voltage (Vin). The controller (CONTR) adjusts the output voltage (Vout) relative to a reference voltage (Vref) specific to each electronic subsystem to be supplied with power.

The regulator includes a capacitor (10) at its output which is adapted to be charged periodically by the input voltage (Vin) and periodically to supply its charge to the electronic subsystem of the terminal when said electronic subsystem requires to be supplied with power.

The capacitor (10) is connected in parallel with a feedback network (15) which samples a portion of the output voltage (Vout) and supplies a measured value of the output voltage (Vout) to the controller (CONTR).

The feedback network (15) comprises at least two transistors (20, 30), a voltage comparator (COMP), and a switch (40) between the output of the comparator (COMP) and the input of the controller (CONTR).

The feedback network (15) samples approximately 1% of the output voltage (Vout) in order to measure the value thereof and to compare it in the comparator (COMP) with the reference voltage (Vref).

When the electronic subsystem requires no power, the switch (40) is open. However, note that the capacitor (10) discharges into the feedback network (15) and a leakage current is created and consumed by the resistors (20, 30).

FIG. 3 is an electrical circuit diagram of the invention, which proposes an improvement to existing voltage regulators.

This voltage regulator supplies a regulated output voltage (Vout) to an electronic subsystem of the communication terminal to be supplied with power.

The regulator is itself connected to an energy store, such as a storage battery, and is supplied with power at an input voltage (Vin).

Like the prior art regulator, this regulator comprises a controller (CONTR), a capacitor (10), a feedback network (15), which comprises at least two transistors (20, 30), a voltage comparator (COMP), and a switch (40), all disposed in exactly the same way as in the prior art regulator.

According to the invention, a switch (50) is inserted into the feedback network between the input of the feedback network and the first transistor (20).

The switch (50) is open when the electronic subsystem, for example a radio preamplifier, does not require to be supplied with power.

Otherwise the switch (50) is closed.

When the switch (50) is open, there is no leakage current as in the prior art regulator.

The capacitor (10) can therefore charge more quickly to the value of the output voltage (Vout) for optimum functioning of the preamplifier.

This implies optimum functioning of the voltage regulator, as shown in FIG. 1C:

A radio preamplifier requires no power during the low voltage time interval (5) between two high voltage time intervals (6) and (7) shown in FIG. 1C.

Comparing FIGS. 1B and 1C, we note that the voltage regulator is reactivated ta2 ms before the second high voltage time interval (7) in order for the output voltage of the regulator to reach the value (Vout) necessary for the radio preamplifier to function in an optimum manner. This time interval ta2 is much shorter than the time interval ta1.

Also, the voltage regulator according to the invention must change from a non-zero output voltage to the necessary output voltage (Vout), which represents a voltage difference Dv2 much less than the voltage difference Dv1.

Note therefore that there is a considerable saving of energy, since there is no leakage current and the voltage regulator charges very quickly before each voltage rise.

1. A voltage regulator for an electronic device, the regulator supplying a regulated output voltage (Vout) from an input voltage (Vin), the output voltage (Vout) being applied to an electronic subsystem of the electronic device adapted to be supplied with power, said regulator comprising a controller (CONTR) receiving the input voltage (Vin), a capacitor (10) situated at the output of the regulator and adapted to be charged periodically by the input voltage (Vin) and periodically to supply its charge to the electronic subsystem of the electronic device when said electronic subsystem requires to be supplied with power, the capacitor (10) being connected in parallel with a feedback network for sampling a portion of the output voltage (Vout) and supplying a measured value of the output voltage (Vout) to the controller (CONTR), the feedback network comprising at least two transistors (20, 30), a voltage comparator (COMP), and a switch (40) situated between the output of the comparator (COMP) and the input of the controller (CONTR), which voltage regulator is characterized in that a switch (50) is inserted into the feedback network between the input of the feedback network and the first transistor (20), the switch (50) being open when the electronic subsystem requires no power.

2. A voltage regulator according to claim 1, characterized in that the voltage comparator (COMP) compares the sampled portion of the output voltage to a reference voltage (Vref) characteristic of the electronic subsystem adapted to be supplied with power.

3. A voltage regulator according to claim 1, characterized in that the comparator (COMP) is a regulation control transistor adapted to supply the exact voltage required by the electronic subsystem to function in an optimum manner.

4. A voltage regulator according to Claim 1, characterized in that the electronic device is a radio terminal.
